(19) United States
(12) Patent Application Publication
(10) Pub. No.: US 2021/0023812 A1
(43) Pub. Date: Jan. 28, 2021

(54) FILM MATERIAL WITH CUTTING GRAIN

(71) Applicant: CHANCE LINE INDUSTRIAL CO., LTD., Siansi Township (TW)

(72) Inventor: Ming-Hsien YAO, Siansi Township (TW)

(21) Appl. No.: 16/936,100

(22) Filed: Jul. 22, 2020

(30) Foreign Application Priority Data
Jul. 24, 2019 (TW) 108126252

(51) Int. Cl. B32B 3/30; B32B 7/12; B32B 27/32; B32B 27/08

(52) U.S. Cl. CPC B32B 3/30; B32B 7/12; B44C 1/172; B32B 27/08; B32B 27/32

(57) ABSTRACT

The invention relates to a film material comprising: a surface film layer, one surface of the surface film layer forms a cut surface with a cutting grain; a thermal bonding layer located on another surface of the surface film layer; and an adhering layer with an adhering surface. The cut surface of the surface film layer is bonded to the adhering surface of the adhering layer. The film material can be provided to cut out a pattern, and the pattern can be adhered to a surface of an article; the pattern has the cutting grain formed by the cut surface. The film material of the present invention is capable of solving the difficulty of eliminating waste other than patterns. Furthermore, at least one inner film layer can be disposed between the surface film layer and the thermal bonding layer to cause the cut surface of the film material to exhibit a multi-color effect.

### BACKGROUND OF THE INVENTION

### Field of Invention

The invention relates to a film material, and more particularly to a film material capable of being used to cut out graphics and/or texts.

### Related Art

When clothes show texts and/or graphics, they can be appealing to the eye and can create uniqueness. In order to achieve this object, the traditional method prints graphics/texts on clothing, so that the clothing has graphics and/or texts. However, those who employ printing method must make screens for printing. The more styles of texts and/or graphics that need to be printed, the more time it takes to proof and make more screens, and thus the cost of making a plate will be very expensive. Because of the slow and time-consuming proofing, the rate of changing graphics/texts is relatively slow, which is not in line with the current fast-changing trend.

The inventor has invented patent application Nos. 15/298,486 and 16/751,010. The technical contents of these two applications are related to a film material that enables consumers or enterprises to cut texts/graphics on the film material, and the cut texts/graphics are pasted on clothes, so as to avoid the drawbacks of time-consuming and costly proofing and plate making of the printing technology mentioned above, and the styles of the texts/graphics can be changed at will.

The inventor upholds the spirit of striving for perfection, and has developed an innovative film material of the present invention capable of being used to cut out texts/graphics.

### SUMMARY OF THE INVENTION

An object of the present invention is to provide a film material, the film material has been pre-made with a cutting grain for a user to further cut out texts and/or graphics from the film material.

Another object of the present invention is to provide the above-mentioned film material, a structure thereof is easy to peel off unnecessary materials other than the cut texts/graphics.

Yet another object of the present invention is to provide the above-mentioned film material capable of providing a double-color or multi-color effect.

The film material provided by the present invention includes:

a surface film layer, a first surface thereof forms a cut surface with cut marks to cause the cut surface to form a cutting grain;

a thermal bonding layer located on a second surface of the surface film layer;

the cut marks cut into the surface film layer without cutting off the thermal bonding layer; and

an adhering layer having an adhering surface; the cut surface of the surface film layer is bonded to the adhering surface of the adhering layer.

Preferably, the cut marks of the cut surface cut off the surface film layer to cause the cut surface to form a plurality of independent cut pieces.

Preferably, the adhering surface of the adhering layer has repeatable adhesion to cause the cut pieces capable of adhering to the adhering surface.

In this way, the film material is capable of being used to cut out a pattern (texts/graphics), and a cutting mark of the pattern cuts off the thermal bonding layer to reach the surface film layer. The pattern is adhered to a surface of an article with a heating device. The cutting grain formed by the cut surface becomes a grain of the pattern, and the cutting grain makes the pattern softer and more flexible to be capable of reliably adhering to the surface of the article.

The preset cutting grain and the cut pieces on the film material do not affect cutting of the pattern, do not affect removal of cut waste, and do not affect sticking of the pattern.

Preferably, further comprising: at least one inner film layer disposed between the surface film layer and the thermal bonding layer, and provided with cut marks with at least one type of depth to cause the cut surface and the pattern to be capable of presenting effects of three-dimensional look and multiple colors.

### BRIEF DESCRIPTION OF THE DRAWINGS

The objects, features and achieved efficacies of the present invention can be understood from the description and figures of several preferred embodiments below, wherein:

FIG. 1 is a front view of a film material according to one preferred embodiment of the present invention, a cut surface of the film material has been pre-cut with a grain, wherein FIGS. 1 to 5 are shown with a thermal bonding layer located at a lower side;

FIG. 2 is a cross-sectional view taken along section line 2-2 of FIG. 1;

FIG. 3 is a front view of the film material of FIG. 1 excluding an adhering layer;

FIG. 4 is a cross-sectional view taken along section line 4-4 of FIG. 3;

FIGS. 5(A) to 5(C) are schematic diagrams showing several forms of the cutting grain on the cut surface of the film material;

FIG. 6 is a schematic diagram of a manufacturing process of the film material of the present invention;

FIG. 7 is a schematic diagram showing a cut pattern of the film material, and FIGS. 7 to 10 are shown with the thermal bonding layer located at an upper side and the adhering layer located at a lower side;

FIG. 8 is a cross-sectional view taken along section line 8-8 of FIG. 7;

FIG. 9 shows that unnecessary parts have been removed from the film material of FIG. 7, leaving only parts of texts and graphics formed by cutting;

FIG. 10 is a cross-sectional view taken along section line 10-10 of FIG. 9;

FIG. 11 is a view of the pattern of the film material of FIG. 9 pasted on an article;

FIG. 12 is a view of the pattern adhered to the article;

FIG. 13 is a schematic diagram showing the pattern has been pasted;

FIG. 14 is a front view of the film material according to a second preferred embodiment of the present invention, wherein FIGS. 14 to 16 are shown with the thermal bonding layer located at a lower side;

FIG. 15 is a cross-sectional view of the film material of FIG. 14 excluding the adhering layer;

FIG. 16 is a cross-sectional view of the film material of FIG. 14;

FIG. 17 is a cross-sectional view of the film material showing the cut pattern with waste removed;

FIG. 18 is a schematic diagram partially showing a pattern of the preferred embodiment;

FIG. 19 is a schematic diagram partially showing another pattern of the preferred embodiment;

FIG. 20 is a cross-sectional view of the film material according to a third preferred embodiment of the present invention showing the cut pattern of the film material with waste removed; and

FIG. 21 is a schematic diagram partially showing a pattern of the film material of FIG. 20.

### DETAILED DESCRIPTION OF THE INVENTION

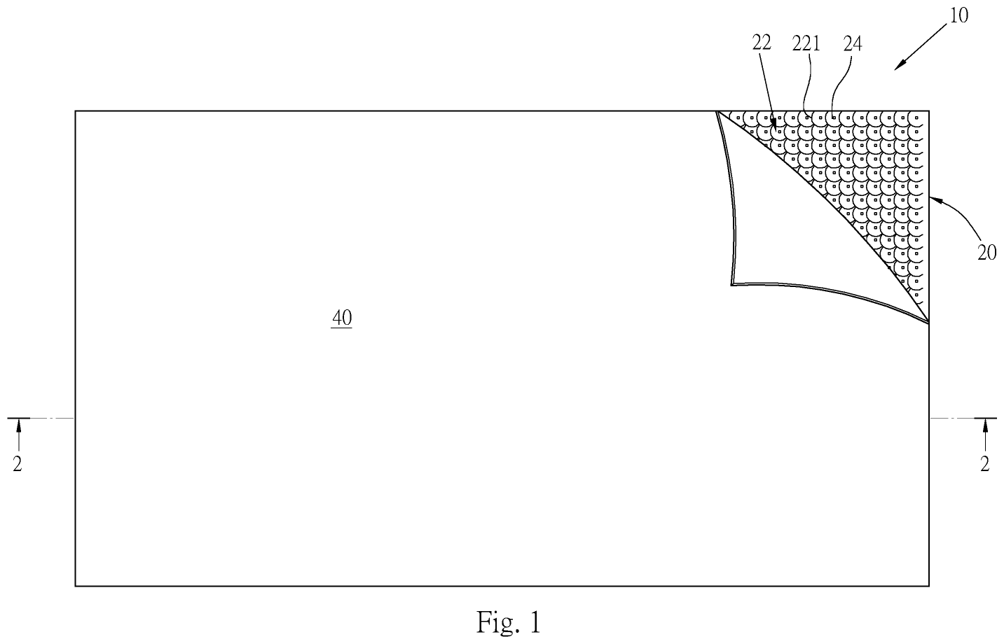

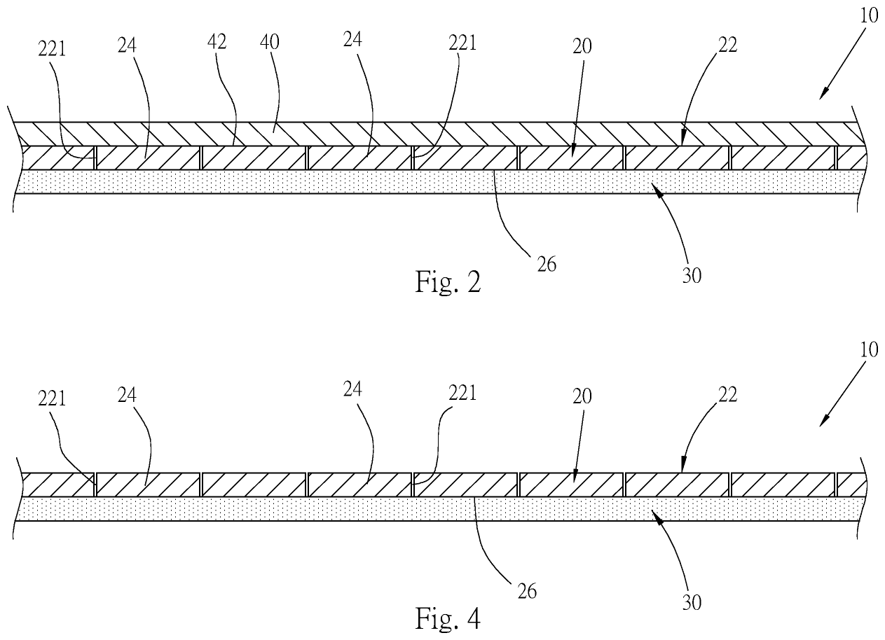

Please refer to FIG. 1 and FIG. 2 showing a film material 10 provided by one preferred embodiment of the present invention including: a surface film layer 20, a thermal bonding layer 30 and an adhering layer 40, wherein, according to directions shown in the figures, a second surface 26 (e.g. bottom surface) of the surface film layer 20 is bonded to the thermal bonding layer 30, and a first surface (e.g. top surface) of the surface film layer 20 is bonded to the adhering layer 40. The first surface of the surface film layer 20 in contact with the adhering layer 40 is a cut surface 22.

In this embodiment, the surface film layer 20 is made of polyurethane (PU), but can also be gold foil, polyethylene terephthalate (PET), polyvinyl chloride (PVC), thermoplastic polyurethanes (TPU) or thermoplastic-rubber material (TPR), the surface film layer 20 can be made with a variety of different colors, and can have different textures, such as an appearance that is metallic or reflective.

In this embodiment, the thermal bonding layer 30 is a hot-melt adhesive layer, which can generate adhesion when being heated.

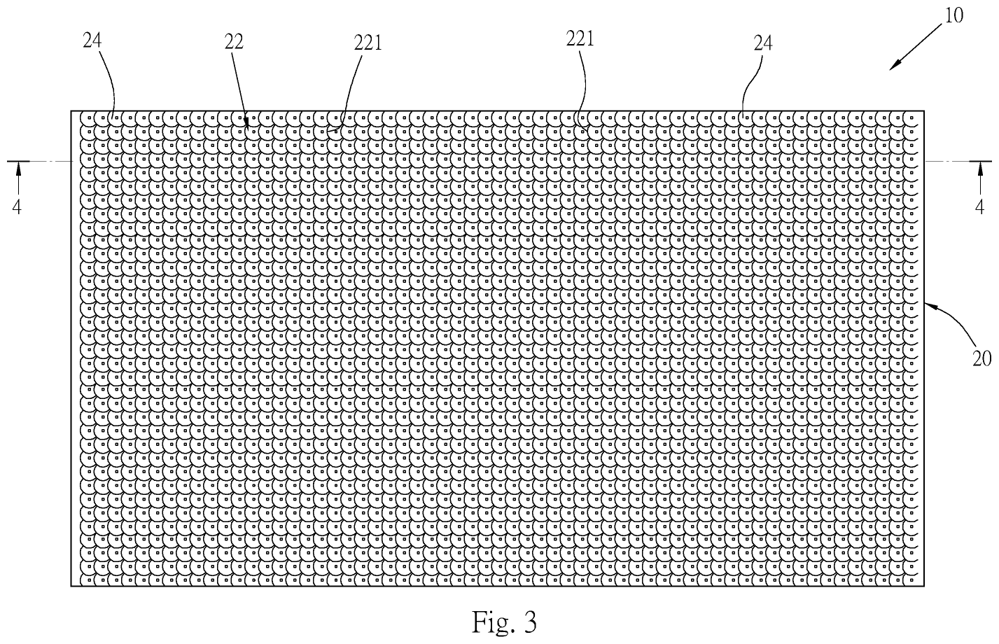

Please refer to FIG. 3 and FIG. 4, the cut surface 22 of the surface film layer 20 has been pre-cut with cut marks 221, so that the cut surface 22 exhibits regular or irregular cutting grains of various forms, and the cut marks 221 are cut into the surface film layer 20. The preferred embodiment uses laser cutting technology to cut regular grains/lines on the cut surface 22, and the cut marks 221 of grains/lines can cut off or do not cut off the surface film layer 20, but do not cut off the thermal bonding layer 30. In this embodiment, the cut marks 221 cut off the surface film layer 20 to cause the cut surface 22 to have a plurality of independent cut pieces 24 in the form of embroidery pieces. The cut marks 221 of the cut surface 22 not only make a surface of the film material 10 to have grains/lines, but also make the film material 10 softer, have better tactile impression, and form fine grains/lines in appearance.

In cutting operation, a cutting depth of the cut marks 221 may cut to the thermal bonding layer 30, but does not cut off the thermal bonding layer 30.

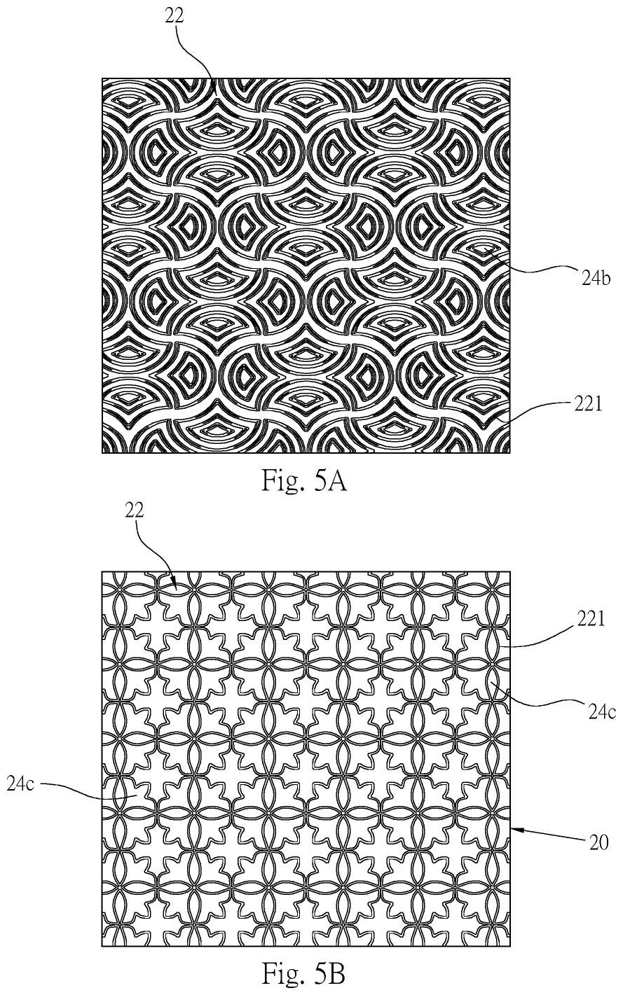

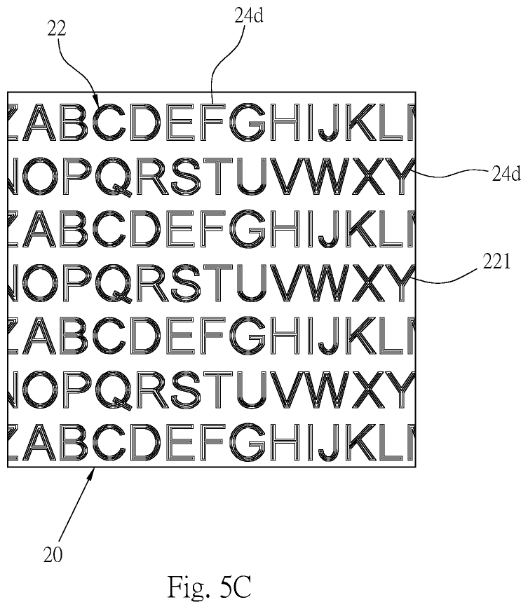

The cut surface 22 of the surface film layer 20 can be cut to form various grains/lines, but not limited to a grain shown in FIG. 3, for example, can be grains shown in FIGS. 5(A) to 5(C), but not limited thereto, the cut surface 22 of the surface film layer 20 has different cutting grains and can be cut to form cut pieces 24b, 24c and 24d of different shapes.

The adhering layer 40 is bonded to the cut surface 22 of the surface film layer 20 to form the film material 10. The adhering layer 40 has heat resistance, and one surface thereof is an adhering surface 42 to be pasted or bonded to the cut surface 22 of the surface film layer 20. Adhesion between the adhering layer 40 and the surface film layer 20 is preferably easy to peel off/separate, but not limited thereto. In addition, the adhering surface 42 is preferably to have repeatable stickiness.

A layer of adhesive (not shown) can be provided on one surface of the adhering layer 40 to form the adhering surface 42, the adhesive does not have residual glue phenomenon, that is, when the surface film layer 20 and the adhering layer 40 are separated, there will be no residue of the adhesive layer on the cut surface 22, in other words, glue of the adhesive layer will not remain on the surface of the surface film layer 20. In addition, the adhering surface 42 of the adhering layer 40 can be electrostatically processed to bond to the surface film layer 20 by means of electrostatic attraction, so it is not necessary for the adhering surface 42 to be provided with adhesive.

In this preferred embodiment, the adhering layer 40 is made of polyethylene terephthalate (PET) to be capable of withstanding high temperatures, such as 100-180 degrees Celsius.

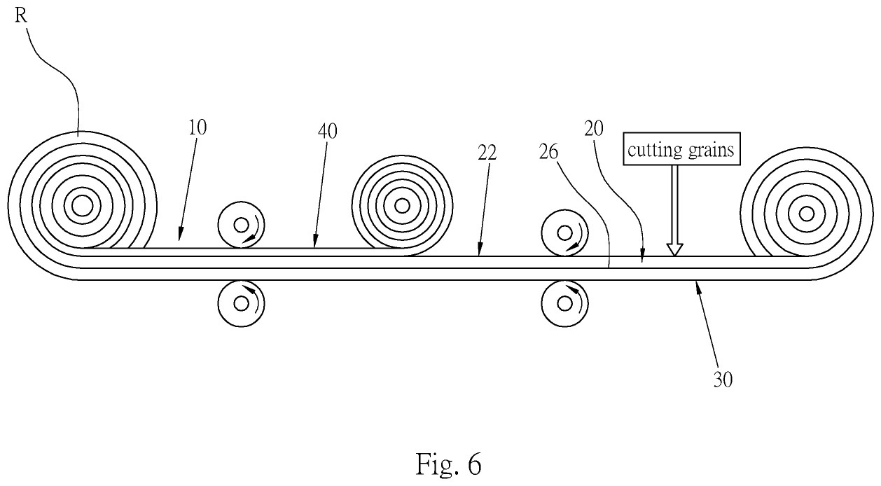

A manufacturing process of the film material 10 can be referred to FIG. 6. Firstly, the surface film layer 20 and the thermal bonding layer 30 that are bonded together are formed, the surface film layer 20 is bonded to the thermal bonding layer 30 with the second surface 26 thereof. After that, the first surface (cut surface) of the surface film layer 20 is cut to form the cut marks 221 and grains/lines. The surface film layer 20 and the thermal bonding layer 30 are bonded to the adhering layer 40 to complete the film material 10 of the present invention, and the film material 10 is rolled into a roll R for use. The manufacturing process of the film material 10 can be done in stages, that is: in a first stage, the surface film layer 20 and the thermal bonding layer 30 are bonded and the cut surface 22 is made, and then the adhering layer 40 is bonded to the cut surface 22 in a second stage.

The film material 10 of the present invention can be provided for enterprises or consumers to cut out various patterns (graphics and/or texts) of different styles using cutting devices or cutters, and a cut pattern is pasted on an article, for example, on a surface of a fabric (clothing), so that the cut texts and/or graphics are pasted on a surface of the article.

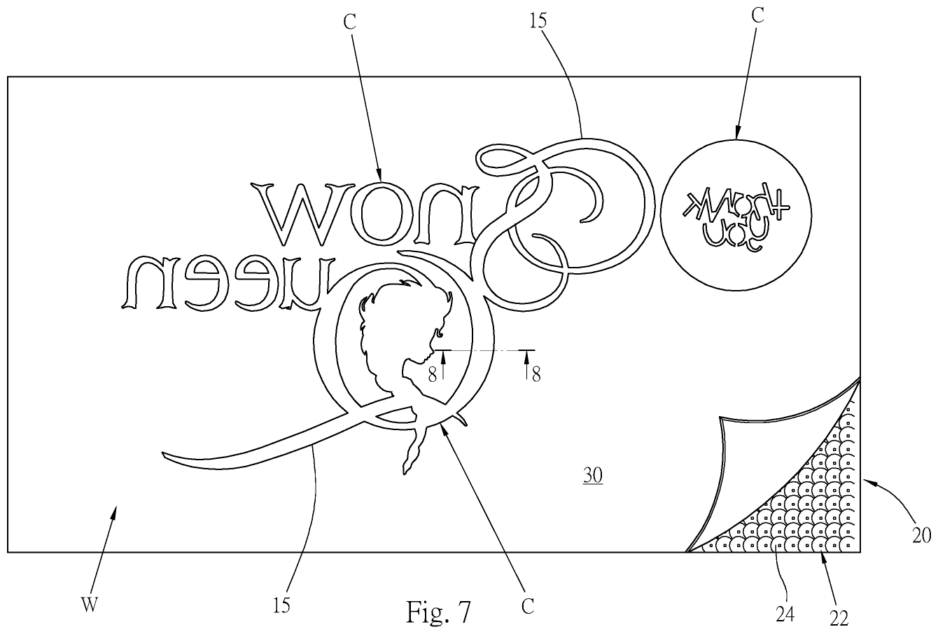

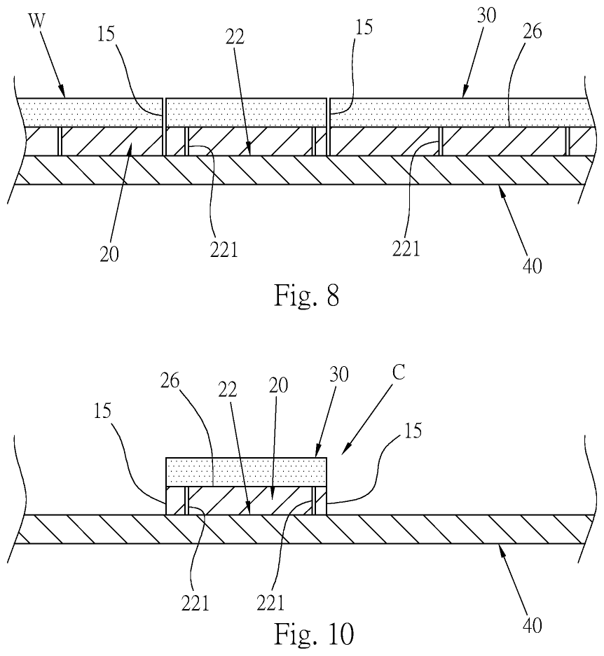

Please refer to FIG. 7 and FIG. 8, when a pattern (graphics and/or texts) needs to be cut out, the thermal bonding layer 30 and the surface film layer 20 are cut to cut out texts and graphics to be pasted, for example, Snow Queen, thank you and a cartoon character graphic located at the letter Q in Queen, as shown in a pattern marked with symbol C of FIG. 7, the cut pattern C is a mirror image. The pattern C (texts and graphic) is formed by cutting with cutting marks 15, the cutting marks 15 cut off the thermal bonding layer 30 and the surface film layer 20, but do not cut off the adhering layer 40. Parts other than the pattern C are a cut waste W being an unused material.

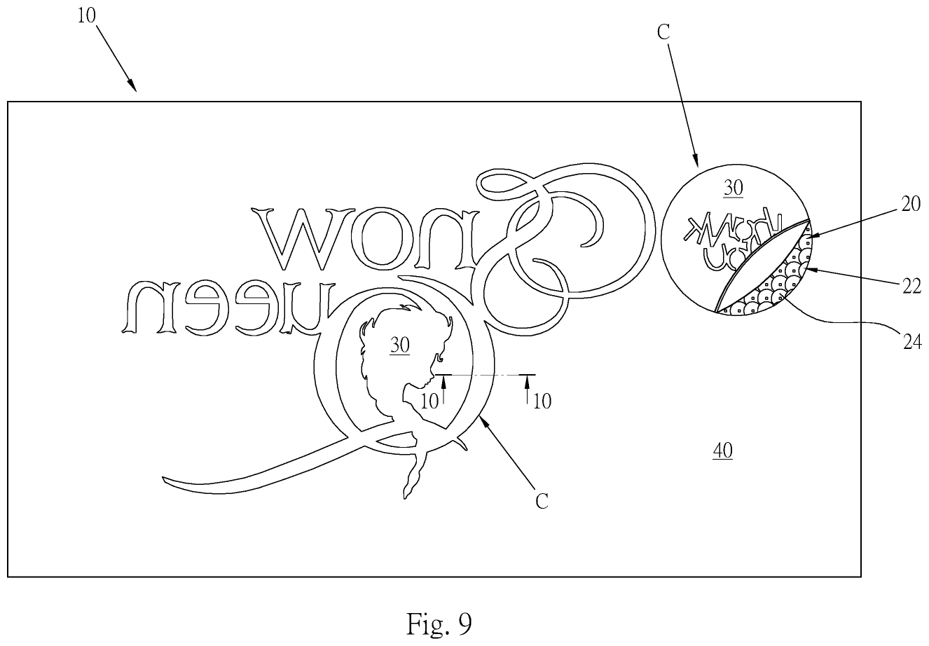

After cutting of the pattern C is completed, the cut waste W is torn off to leave the cut pattern C. FIGS. 9 and 10 show that the cut waste W has been removed, and only the cut pattern C is left, wherein: in this embodiment, Snow Queen and the cartoon character graphic are presented with real lines, while thank you is presented with a hollow font. As shown in FIG. 10, after removing the cut waste W, the remaining pattern C still has the surface film layer 20 and the thermal bonding layer 30, and the pattern C is still adhered on the adhering layer 40.

In implementation, a bonding strength between the surface film layer 20 and the thermal bonding layer 30 is greater than a bonding strength between the surface film layer 20 and the adhering layer 40. Therefore, when the cut waste W is torn off and peeled off, the waste W (the surface film layer 20 and the thermal bonding layer 30 that do not belong to the pattern C) can be easily separated from the adhering layer 40, leaving only the pattern C adhered on the adhering layer 40.

It should be explained that in the process of removing the cut waste W, if any part of the pattern C (for example, the cut piece 24) comes off from the adhering layer 40, resulting in an incomplete pattern, due to the adhering surface 42 having repeatable adhesion, the any part (the cut piece 24) can be adhered back to the adhering surface 42 to restore the integrity of the pattern.

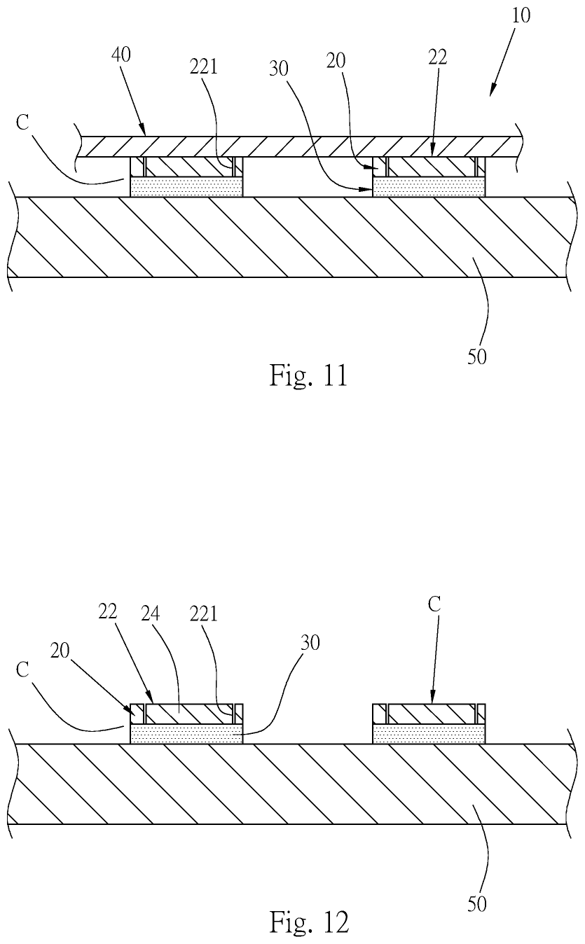

After the cut waste W is removed, then, as shown in FIG. 11, the film material 10 with the pattern C is placed on an article 50 to be adhered, a surface of the article 50 is contacted with the thermal bonding layer 30, and then the film material 10 is heated with a heating device, for example, an iron or a pressing machine to cause the thermal bonding layer 30 to form an adhesive, and the surface film layer 20 of the pattern C is stuck on the article 50. The adhering layer 40 is capable of withstanding heating temperature.

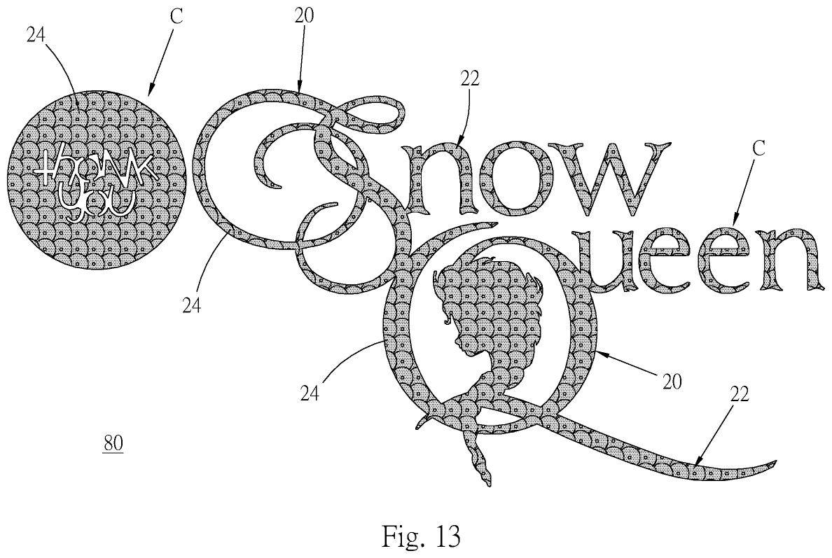

After that, the adhering layer 40 is removed, as shown in FIG. 12, only the surface film layer 20 remains to be adhered on the article 50. An adhering force between the adhering layer 40 and the surface film layer 20 is weak, and it is easy to tear off. FIG. 13 shows the pattern C (texts and/or graphics) cut out from the film material 10 is adhered on the surface of the article 50, and the pattern C is presented on the article 50 with a front view facing outward (non-mirror image). The grains/lines are presented on the pattern C.

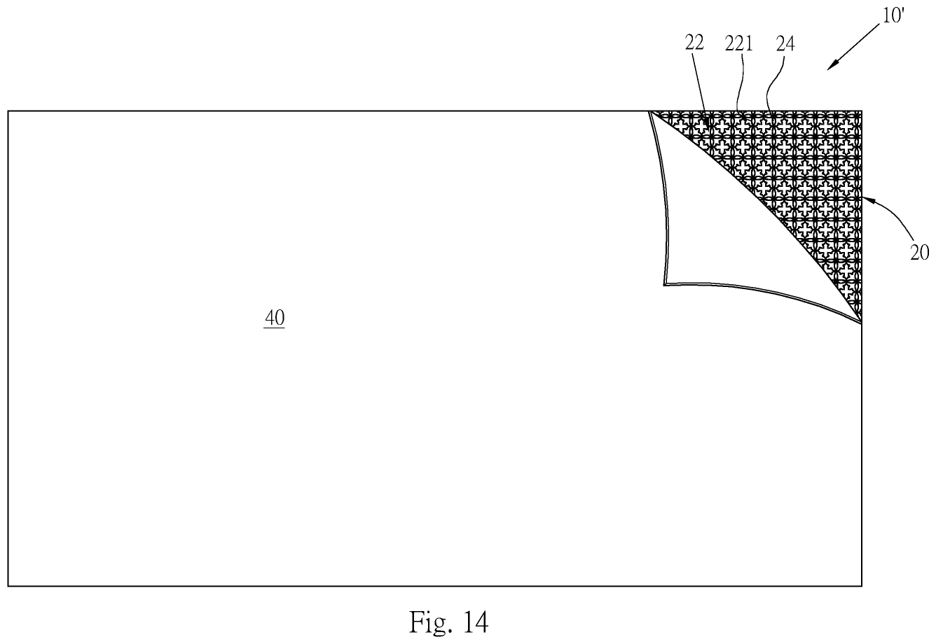

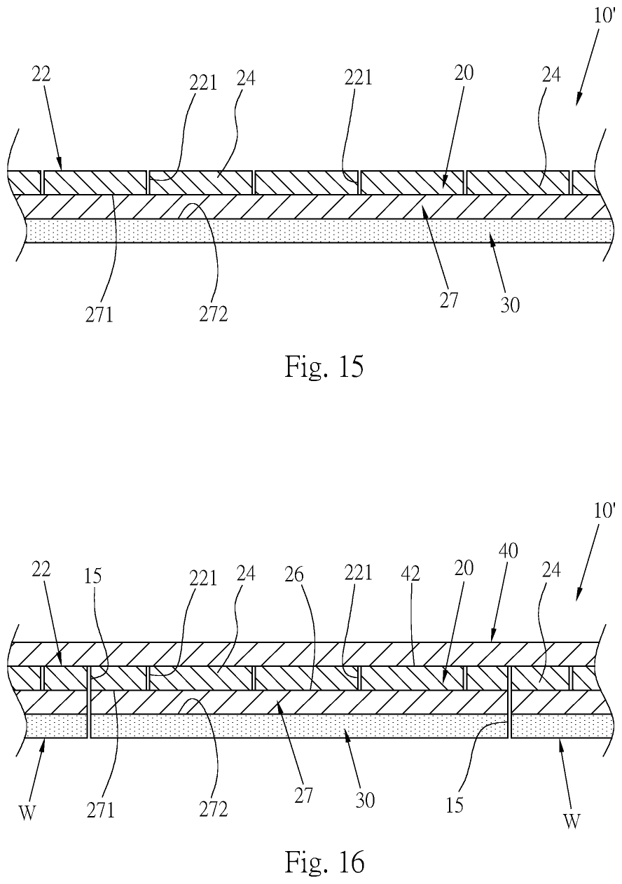

FIGS. 14 to 16 are a second preferred embodiment of a film material 10′ of the present invention including: the surface film layer 20, an inner film layer 27, the thermal bonding layer 30 and the adhering layer 40. The structure of this preferred embodiment is generally the same as that of the first preferred embodiment, and the inner film layer 27 is further disposed between the surface film layer 20 and the thermal bonding layer 30. A first surface 271 of the inner film layer 27 is bonded to the second surface 26 of the surface film layer 20, and a second surface 272 of the inner film layer 27 is bonded to the thermal bonding layer 30.

The inner film layer 27 is a film layer located on an inner side of the surface film layer 20, material of the inner film layer 27 can be the same as that of the surface film layer 20, and can also be made with a metallic appearance or a reflective effect. Preferably, the inner film layer 27 and the surface film layer 20 have different colors, for example, the inner film layer 27 has a dark color, and the surface film layer 20 has a light color; and vice versa, in order to produce color contrast.

The first surface of the surface film layer 20 is the cut surface 22, and grains/lines and the cut pieces 24 have been cut with the cut marks 221, preferably the cut marks 221 cut off the surface film layer 20. After the cut surface 22 is cut, the adhering surface 42 of the adhering layer 40 and the cut surface 22 of the surface film layer 20 are bonded together.

A bonding force between the surface film layer 20 and the inner film layer 27 and a bonding force between the inner film layer 27 and the thermal bonding layer 30 are higher than a bonding force between the surface film layer 20 and the adhering layer 40, and therefore, the adhering layer 40 and the surface film layer 20 are relatively easy to separate.

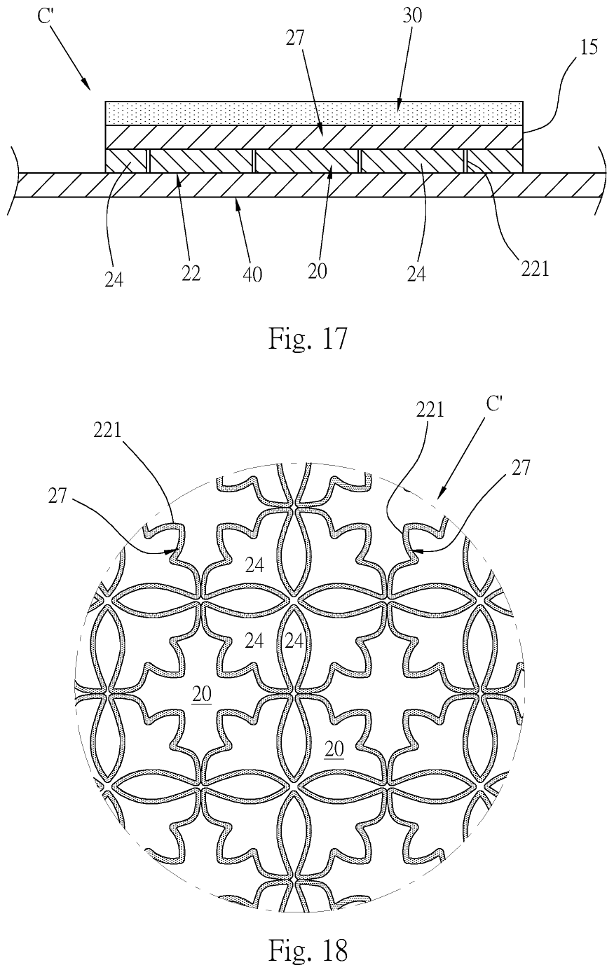

Please refer to FIGS. 16 and 17, the thermal bonding layer 30, the inner film layer 27 and the surface film layer 20 of the film material 10′ are cut with a cutting tool or device to cut out a pattern C′ (graphics and/or texts), the cutting marks 15 of the pattern C′ cut off the thermal bonding layer 30, the inner film layer 27 and the surface film layer 20, but do not cut off the adhering layer 40. Parts other than the pattern C′ are the cut waste W (the surface film layer 20, the inner film layer 27, and the thermal bonding layer 30 that are not part of the pattern C′) being an unused material.

After cutting of the pattern C′ is completed, the cut waste W is removed, leaving the cut pattern C′ as shown in FIG. 17. Since the bonding force between the surface film layer 20 and the adhering layer 40 is relatively weak, it is easy to tear off and peel off the cut waste W. Then, the pattern C′ of the film material 10 is thermally adhered to a surface of an article with a heating device, and finally the adhering layer 40 is removed to complete pasting of the pattern C′.

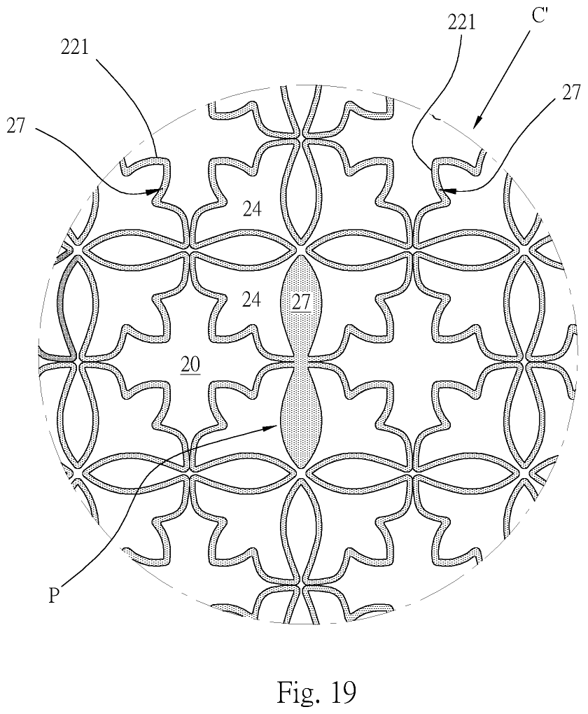

Please refer to FIG. 18, which shows a part of the pattern C′ pasted on an article. Since the film material 10′ of this embodiment has the two film layers 20, 27, in the pattern C′ of this embodiment, the inner film layer 27 can be exposed in the cut marks 221 of the surface film layer 20. Thus, when the surface film layer 20 and the inner film layer 27 are made to have different colors, the pattern C′ reveals two colors. In addition, before removing the cut waste W and performing thermal bonding, a user can also remove cut pieces at specific positions of the film material 10′, for example, a cut piece shown at a position P in FIG. 19 is removed. In this way, shape and color of the inner film layer 27 at the position P are more prominent, enhancing the richness of the pattern C′.

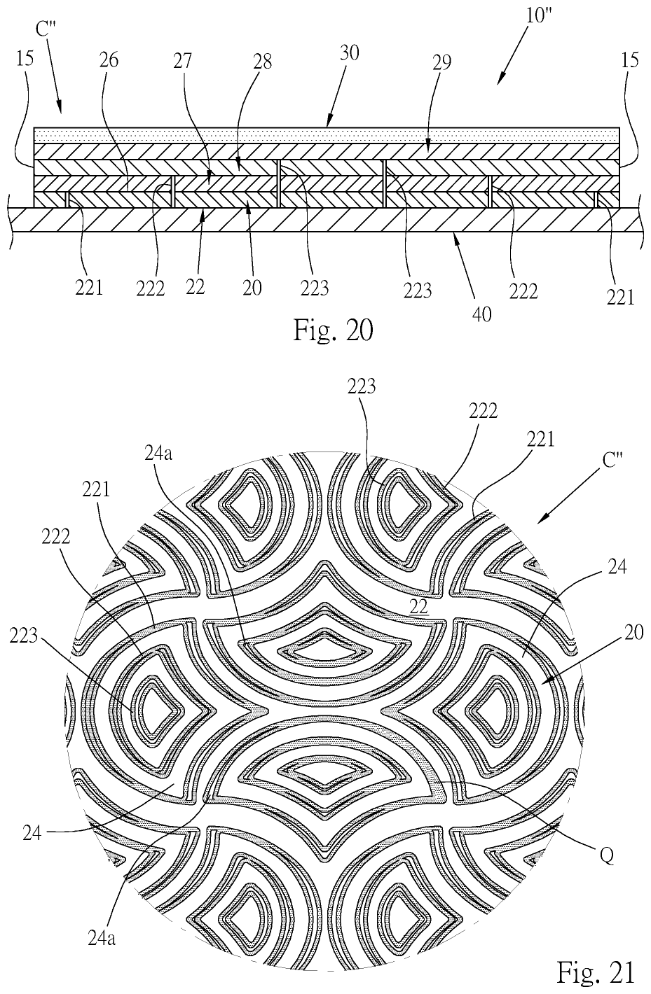

One or more than one of the inner film layers can be provided between the surface film layer 20 and the thermal bonding layer 30 of the film material. A film material 10″ of a third preferred embodiment of FIGS. 20 and 21 discloses two or more than two of the inner film layers. The film material 10″ has: the surface film layer 20, a first inner film layer 27, a second inner film layer 28, a third inner film layer 29, the thermal bonding layer 30 and the adhering layer 40. The first, second, and third inner film layers 27, 28, 29 are adhered between the surface film layer 20 and the thermal bonding layer 30, and are sequentially arranged in a direction from the surface film layer 20 toward the thermal bonding layer 30. The first inner film layer 27 is bonded to the second surface 26 of the surface film layer 20; the second inner film layer 28 is bonded to another surface of the first inner film layer 27; the third inner film layer 29 is disposed between the second inner film layer 28 and the thermal bonding layer 30. The three inner film layers 27, 28, 29 are preferably made with different colors.

A plurality of cut marks 221, 222, 223 are formed by cutting the film material 10″, so that the cut surface 22 is formed with grains/lines, and the cut surface 22 has the cut pieces 24 and small-sized cut pieces 24a. Wherein: the cut marks 221, 222, 223 have different (cutting) depths, a cutting depth of the first cut mark 221 only cuts off the surface film layer 20, and does not cut off any of the inner film layers 27˜29; a cutting depth of the second cut mark 222 only cuts off the surface film layer 20 and the first inner film layer 27; and a cutting depth of the third cut mark 223 cuts off the surface film layer 20 and the first and second inner film layers 27, 28, but does not cut off the third inner film layer 29. Then, a pattern C″ is cut out from the film material 10″ with the cutting marks 15 and the cut waste W is removed to form the film material 10″ of FIG. 20. Then, the pattern C″ of the film material 10″ is adhered to an article with a heating device or appliance, as shown in FIG. 21.

Since the film material 10″ of this embodiment has the inner film layers 27 to 29 and the cut marks 221 to 223 with different (cutting) depths, in addition to the cut surface 22 of the pattern C″ having cut grains/lines and a color of the surface film layer 20, other colors can be presented, that is, the first inner film layer 27 and its color are exposed at the first cut marks 221, the second inner film layer 28 and its color are exposed at the second cut marks 222, and the third inner film layer 29 and its color are exposed at the third cut marks 223. Thus, the pattern C″ presents four colors.

When peeling off/removing the cut waste W, if some of the cut pieces 24 or small cut pieces 24a are removed, for example, the small cut piece 24a shown at a position Q is peeled off with the cut waste W, a color of the first inner film layer 27 can be displayed at the position Q.

The film materials 10, 10′ and 10″ provided by the present invention can be used to cut out the various patterns (texts and graphics) C, C′ and C″ to be conveniently pasted on an article. The texts and graphics of the patterns can be cut according to a required style, speed of changing graphics/texts is fast, and plate making is not required. The cutting grain on the surface film layer 20 and the pre-set cut pieces 24 do not affect cutting of the pattern, removal of the cut waste W and sticking of the pattern. According to the design of the present invention, the cut waste W can be conveniently removed, and the cut pattern (texts/graphics) can be quickly and conveniently adhered to a surface of the article.

The cutting grain/line formed on the cut surface 22 of the film material 10 becomes the grain/line of the pattern C, and the cutting grain/line makes the pattern C softer and more flexible, the pattern C can be reliably adhered on the surface of the article, and can be bent and flexed with the article (for example, fabric).

In the present invention, the cut surface 22 of the film materials 10′, 10″ and the patterns C′, C″ can have a two-color and multi-color appearance to enhance stereoscopic and color changing effects of the patterns C′, C″.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. A film material with a cutting grain including:
a surface film layer, one surface thereof forming a cut surface with a cutting grain; another surface of the surface film layer being a second surface;
a thermal bonding layer located on the second surface of the surface film layer, capable of generating adhesion when being heated; the second surface of the surface film layer being directly or indirectly bonded to the thermal bonding layer; and
an adhering layer having an adhering surface; the cut surface of the surface film layer being bonded to the adhering surface of the adhering layer;
the cutting grain having cut marks formed on the cut surface, and the cut marks cutting into the surface film layer from the cut surface without cutting off the thermal bonding layer.

2. The film material as claimed in claim 1, wherein the cut marks of the cutting grain cut off or do not cut off the surface film layer.

3. The film material as claimed in claim 1, further comprising at least one inner film layer disposed between the surface film layer and the thermal bonding layer; and the cut marks with at least one type of depth cutting into the surface film layer from the cut surface without cutting off the thermal bonding layer

4. The film material as claimed in claim 3, comprising at least two inner film layers disposed between the surface film layer and the thermal bonding layer; and the cut marks with at least two types of depths cutting into the surface film layer and the at least two inner film layers from the cut surface without cutting off the thermal bonding layer.

5. The film material as claimed in claim 1, wherein the adhering surface of the adhering layer has repeatable adhesion.

6. The film material as claimed in claim 1, wherein the film material is cut out with a pattern, and a cutting mark of the pattern cuts off the thermal bonding layer to reach the surface film layer.

7. The film material as claimed in claim 2, wherein the film material is cut out with a pattern, and a cutting mark of the pattern cuts off the thermal bonding layer to reach the surface film layer.

8. The film material as claimed in claim 6, wherein parts other than the pattern are a cut waste that can be removed.

9. The film material as claimed in claim 3, wherein the film material is cut out with a pattern, and a cutting mark of the pattern cuts off the thermal bonding layer, the inner film layer and the surface film layer.

10. The film material as claimed in claim 9, wherein parts other than the pattern are a cut waste, and the cut waste is removed.

11. The film material as claimed in claim 3, wherein the cut marks include a cut mark with a cutting depth at least cutting off the surface film layer, and the at least one inner film layer is exposed at the cut mark with the cutting depth.

12. The film material as claimed in claim 4, wherein the inner film layers at least include a first inner film layer and a second inner film layer arranged from the surface film layer toward the thermal bonding layer; the cut marks at least include a first cut mark with a first depth and a second cut mark with a second depth, the first cut mark with the first depth cuts off the surface film layer; the second cut mark with the second depth cuts off the surface film layer and the first inner film layer; the first inner film layer is exposed at the first cut mark; and the second inner film layer is exposed at the second cut mark.

13. The film material as claimed in claim 3, wherein the surface film layer and at least one of the inner film layers have different colors or different appearance textures.

14. The film material as claimed in claim 11, wherein the surface film layer and at least one of the inner film layers have different colors or different appearance textures.

15. The film material as claimed in claim 3, wherein the surface film layer and each of the inner film layers have different colors or different appearance textures.

16. The film material as claimed in claim 11, wherein the surface film layer and each of the inner film layers have different colors or different appearance textures.

17. The film material as claimed in claim 1, wherein a bonding strength between the surface film layer and the thermal bonding layer is greater than a bonding strength between the surface film layer and the adhering layer.

18. The film material as claimed in claim 1, wherein the cut marks of the cut surface cut off the surface film layer to form a plurality of cut pieces on the cut surface.
